(19) United States
(12) Patent Application Publication
(10) Pub. No.: US 2022/0050239 A1
(43) Pub. Date: Feb. 17, 2022

(54) LIGHT SOURCE, MULTIVIEW BACKLIGHT, AND METHOD WITH A BIFURCATED EMISSION PATTERN

(71) Applicant: LEIA INC., Menlo Park, CA (US)

(72) Inventors: David A. Fattal, Menlo Park, CA (US); Ming Ma, Menlo Park, CA (US)

(21) Appl. No.: 17/512,585

(22) Filed: Oct. 27, 2021

Related U.S. Application Data
(63) Continuation of application No. PCT/US2020/030320, filed on Apr. 28, 2020.
(60) Provisional application No. 62/841,222, filed on Apr. 30, 2019.

(51) Int. Cl. F21V 8/00

(52) U.S. Cl. CPC G02B 6/0036; G02B 6/0031

(57) ABSTRACT

A light source configured to provide output light having a bifurcated emission pattern includes an optical emitter configured to emit light and a emission control layer. The emission control layer includes a first plurality of light-blocking elements spaced apart from one another in a vertical direction at an output aperture of the light source and a second plurality of light-blocking elements displaced from the output aperture and interleaved with the first plurality. The emission control layer is configured to transmit a portion of the emitted light through gaps between the light-blocking elements to provide the output light having the bifurcated emission pattern in the vertical direction. A multiview backlight includes the light source along with a light guide and an array of multibeam elements to provide a plurality of directional light beams using the output light having the bifurcated emission pattern.

### CROSS-REFERENCE TO RELATED APPLICATIONS

This application is a continuation patent application of and claims priority to International Patent Application No. PCT/US2020/030320, filed Apr. 28, 2020, which claims the benefit of priority to U.S. Provisional Patent Application Ser. No. 62/841,222, filed Apr. 30, 2019, the entire contents of both of which are incorporated by reference herein.

### STATEMENT REGARDING FEDERALLY SPONSORED RESEARCH OR DEVELOPMENT

N/A

### BACKGROUND

Electronic displays are a nearly ubiquitous medium for communicating information to users of a wide variety of devices and products. Most commonly employed electronic displays include the cathode ray tube (CRT), plasma display panels (PDP), liquid crystal displays (LCD), electroluminescent displays (EL), organic light emitting diode (OLED) and active matrix OLEDs (AMOLED) displays, electrophoretic displays (EP) and various displays that employ electromechanical or electrofluidic light modulation (e.g., digital micromirror devices, electrowetting displays, etc.). Generally, electronic displays may be categorized as either active displays (i.e., displays that emit light) or passive displays (i.e., displays that modulate light provided by another source). Among the most obvious examples of active displays are CRTs, PDPs and OLEDs/AMOLEDs. Displays that are typically classified as passive when considering emitted light are LCDs and EP displays. Passive displays, while often exhibiting attractive performance characteristics including, but not limited to, inherently low power consumption, may find somewhat limited use in many practical applications given the lack of an ability to emit light.

To overcome the limitations of passive displays associated with emitted light, many passive displays are coupled to an external light source. The coupled light source may allow these otherwise passive displays to emit light and function substantially as an active display. Examples of such coupled light sources are backlights. A backlight may serve as a source of light (often a panel backlight) that is placed behind an otherwise passive display to illuminate the passive display. For example, a backlight may be coupled to an LCD or an EP display. The backlight emits light that passes through the LCD or the EP display. The light emitted is modulated by the LCD or the EP display and the modulated light is then emitted, in turn, from the LCD or the EP display. Often backlights are configured to emit white light. Color filters are then used to transform the white light into various colors used in the display. The color filters may be placed at an output of the LCD or the EP display (less common) or between the backlight and the LCD or the EP display, for example.

### BRIEF DESCRIPTION OF THE DRAWINGS

Various features of examples and embodiments in accordance with the principles described herein may be more readily understood with reference to the following detailed description taken in conjunction with the accompanying drawings, where like reference numerals designate like structural elements, and in which:

FIG. 1A illustrates a perspective view of a multiview display in an example, according to an embodiment consistent with the principles described herein.

FIG. 1B illustrates a graphical representation of the angular components of a light beam having a particular principal angular direction in an example, according to an embodiment consistent with the principles described herein.

FIG. 2 illustrates a cross-sectional view of a diffraction grating in an example, according to an embodiment consistent with the principles described herein.

FIG. 3A illustrates a cross-sectional view of a light source in an example, according to an embodiment consistent with the principles described herein.

FIG. 3B illustrates a magnified cross-sectional view of a portion of the light source of FIG. 3A in an example, according to an embodiment consistent with the principles described herein.

FIG. 4 illustrates a perspective view of an emission control layer in an example, according to an embodiment consistent with the principles described herein.

FIG. 5 illustrates a perspective view of an emission control layer in an example, according to an embodiment consistent with the principles described herein.

FIG. 6A illustrates a cross-sectional view of a groove in a layer of transparent material of an emission control layer in an example, according to an embodiment consistent with the principles described herein.

FIG. 6B illustrates a cross-sectional view of a groove in a layer of transparent material of an emission control layer in an example, according to another embodiment consistent with the principles described herein.

FIG. 6C illustrates a cross-sectional view of a groove in a layer of transparent material of an emission control layer in an example, according to yet another embodiment consistent with the principles described herein.

FIG. 7A illustrates a cross sectional view of a multiview backlight in an example, according to an embodiment consistent with the principles described herein.

FIG. 7B illustrates a perspective view of a multiview backlight in an example, according to an embodiment consistent with the principles described herein.

FIG. 8 illustrates a block diagram of a multiview backlight in an example, according to another embodiment consistent with the principles described herein.

FIG. 9 illustrates a flow chart of a method of light source operation, according to an embodiment consistent with the principles described herein.

Certain examples and embodiments have other features that are one of in addition to and in lieu of the features illustrated in the above-referenced figures. These and other features are detailed below with reference to the above-referenced figures.

### DETAILED DESCRIPTION

Examples and embodiments in accordance with the principles described herein provide a light source having a bifurcated emission pattern and a multiview backlight employing the light source, with application to a multiview display. In particular, embodiments consistent with the principles described herein provide a light source that provides output light having a bifurcated emission pattern, in various embodiments. Further, the light source may be used in a multiview backlight employing multibeam elements configured to provide or emit directional light beams having a plurality of different principal angular directions. In various embodiments, the directional light beams emitted by the multiview backlight using the light source having the bifurcated emission pattern may have directions corresponding to or consistent with view directions of a multiview image or equivalently of a multiview display. The bifurcated emission pattern may provide guided light within the multiview backlight that improves one or both of an illumination efficiency and an overall brightness of the multiview backlight, according to some embodiments.

According to various embodiments, the multiview display that employs the multiview backlight may be a so-called ‘glasses-free’ or autostereoscopic display. Uses of multiview backlighting in multiview displays described herein include, but are not limited to, mobile telephones (e.g., smart phones), watches, tablet computes, mobile computers (e.g., laptop computers), personal computers and computer monitors, automobile display consoles, camera displays, and various other mobile as well as substantially non-mobile display applications and devices.

Herein a ‘two-dimensional (2D) display’ is defined as a display configured to provide a view of an image that is substantially the same regardless of a direction from which the image is viewed (i.e., within a predefined viewing angle or range of the 2D display). A liquid crystal display (LCD) found in many smart phones and computer monitors are examples of 2D displays. In contrast herein, a ‘multiview display’ is defined as an electronic display or display system configured to provide different views of a multiview image in or from different view directions. In particular, the different views may represent different perspective views of a scene or object of the multiview image. In some instances, a multiview display may also be referred to as a three-dimensional (3D) display, e.g., when simultaneously viewing two different views of the multiview image provides a perception of viewing a three-dimensional image.

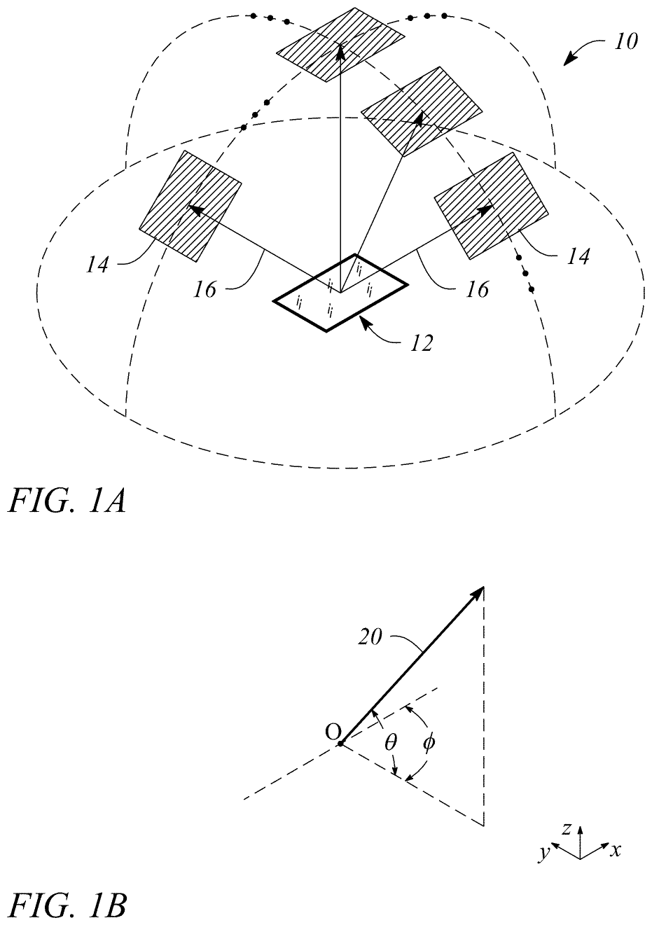

FIG. 1A illustrates a perspective view of a multiview display 10 in an example, according to an embodiment consistent with the principles described herein. As illustrated in FIG. 1A, the multiview display 10 comprises a screen 12 to display a multiview image to be viewed. The multiview display 10 provides different views 14 of the multiview image in different view directions 16 relative to the screen 12. The view directions 16 are illustrated as arrows extending from the screen 12 in various different principal angular directions; the different views 14 are illustrated as shaded polygonal boxes at the termination of the arrows (i.e., depicting the view directions 16); and only four views 14 and four view directions 16 are illustrated, all by way of example and not limitation. Note that while the different views 14 are illustrated in FIG. 1A as being above the screen, the views 14 actually appear on or in a vicinity of the screen 12 when the multiview image is displayed on the multiview display 10. Depicting the views 14 above the screen 12 is only for simplicity of illustration and is meant to represent viewing the multiview display 10 from a respective one of the view directions 16 corresponding to a particular view 14.

A view direction or equivalently a light beam having a direction corresponding to a view direction of a multiview display generally has a principal angular direction given by angular components {θ, ϕ}, by definition herein. The angular component θ is referred to herein as the ‘elevation component’ or ‘elevation angle’ of the light beam. The angular component ϕ is referred to as the ‘azimuth component’ or ‘azimuth angle’ of the light beam. By definition, the elevation angle θ is an angle in a vertical plane (e.g., perpendicular to a plane of the multiview display screen while the azimuth angle ϕ is an angle in a horizontal plane (e.g., parallel to the multiview display screen plane).

FIG. 1B illustrates a graphical representation of the angular components {θ, ϕ} of a light beam 20 having a particular principal angular direction or simply ‘direction’ corresponding to a view direction (e.g., view direction 16 in FIG. 1A) of a multiview display in an example, according to an embodiment consistent with the principles described herein. In addition, the light beam 20 is emitted or emanates from a particular point, by definition herein. That is, by definition, the light beam 20 has a central ray associated with a particular point of origin within the multiview display. FIG. 1B also illustrates the light beam (or view direction) point of origin, O.

Further herein, the term ‘multiview’ as used in the terms ‘multiview image’ and ‘multiview display’ is defined as a plurality of views representing different perspectives or including angular disparity between views of the view plurality. In addition, herein the term ‘multiview’ explicitly includes more than two different views (i.e., a minimum of three views and generally more than three views), by definition herein. As such, ‘multiview display’ as employed herein is explicitly distinguished from a stereoscopic display that includes only two different views to represent a scene or an image. Note however, while multiview images and multiview displays may include more than two views, by definition herein, multiview images may be viewed (e.g., on a multiview display) as a stereoscopic pair of images by selecting only two of the multiview views to view at a time (e.g., one view per eye).

A ‘multiview pixel’ is defined herein as a set of sub-pixels or ‘view’ pixels in each of a similar plurality of different views of a multiview display. In particular, a multiview pixel may have individual view pixels corresponding to or representing a view pixel in each of the different views of the multiview image. Moreover, the view pixels of the multiview pixel are so-called ‘directional pixels’ in that each of the view pixels is associated with a predetermined view direction of a corresponding one of the different views, by definition herein. Further, according to various examples and embodiments, the different view pixels of a multiview pixel may have equivalent or at least substantially similar locations or coordinates in each of the different views. For example, a first multiview pixel may have individual view pixels located at {x₁y₁} in each of the different views of a multiview image, while a second multiview pixel may have individual view pixels located at {x₂y₂} in each of the different views, and so on. In some embodiments, a number of view pixels in a multiview pixel may be equal to a number of views of the multiview display.

Herein, a ‘light guide’ is defined as a structure that guides light within the structure using total internal reflection or ‘TIR’. In particular, the light guide may include a core that is substantially transparent at an operational wavelength of the light guide. In various examples, the term ‘light guide’ generally refers to a dielectric optical waveguide that employs total internal reflection to guide light at an interface between a dielectric material of the light guide and a material or medium that surrounds that light guide. By definition, a condition for total internal reflection is that a refractive index of the light guide is greater than a refractive index of a surrounding medium adjacent to a surface of the light guide material. In some embodiments, the light guide may include a coating in addition to or instead of the aforementioned refractive index difference to further facilitate the total internal reflection. The coating may be a reflective coating, for example. The light guide may be any of several light guides including, but not limited to, one or both of a plate or slab guide and a strip guide.

Further herein, the term ‘plate’ when applied to a light guide as in a ‘plate light guide’ is defined as a piecewise or differentially planar layer or sheet, which is sometimes referred to as a ‘slab’ guide. In particular, a plate light guide is defined as a light guide configured to guide light in two substantially orthogonal directions bounded by a top surface and a bottom surface (i.e., opposite surfaces) of the light guide. Further, by definition herein, the top and bottom surfaces are both separated from one another and may be substantially parallel to one another in at least a differential sense. That is, within any differentially small section of the plate light guide, the top and bottom surfaces are substantially parallel or co-planar.

In some embodiments, the plate light guide may be substantially flat (i.e., confined to a plane) and therefore, the plate light guide is a planar light guide. In other embodiments, the plate light guide may be curved in one or two orthogonal dimensions. For example, the plate light guide may be curved in a single dimension to form a cylindrical shaped plate light guide. However, any curvature has a radius of curvature sufficiently large to ensure that total internal reflection is maintained within the plate light guide to guide light.

As defined herein, a ‘non-zero propagation angle’ of guided light is an angle relative to a guiding surface of a light guide. Further, the non-zero propagation angle is both greater than zero and less than a critical angle of total internal reflection within the light guide, by definition herein. Moreover, a specific non-zero propagation angle may be chosen (e.g., arbitrarily) for a particular implementation as long as the specific non-zero propagation angle is less than the critical angle of total internal reflection within the light guide. In various embodiments, the light may be introduced or coupled into the light guide at the non-zero propagation angle of the guided light.

According to various embodiments, guided light or equivalently a guided ‘light beam’ produced by coupling light into the light guide may be a collimated light beam. Herein, a ‘collimated light’ or ‘collimated light beam’ is generally defined as a beam of light in which rays of the light beam are substantially parallel to one another within the light beam. Further, rays of light that diverge or are scattered from the collimated light beam are not considered to be part of the collimated light beam, by definition herein.

Herein, a ‘diffraction grating’ is generally defined as a plurality of features (i.e., diffractive features) arranged to provide diffraction of light incident on the diffraction grating. In some examples, the plurality of features may be arranged in a periodic or quasi-periodic manner. For example, the diffraction grating may include a plurality of features (e.g., a plurality of grooves or ridges in a material surface) arranged in a one-dimensional (1D) array. In other examples, the diffraction grating may be a two-dimensional (2D) array of features. The diffraction grating may be a 2D array of bumps on or holes in a material surface, for example.

As such, and by definition herein, the ‘diffraction grating’ is a structure that provides diffraction of light incident on the diffraction grating. If the light is incident on the diffraction grating from a light guide, the provided diffraction or diffractive scattering may result in, and thus be referred to as, ‘diffractive scattering’ in that the diffraction grating may scatter light out of the light guide by diffraction. Further, by definition herein, the features of a diffraction grating are referred to as ‘diffractive features’ and may be one or more of at, in, and on a material surface (i.e., a boundary between two materials). The surface may be a surface of a light guide, for example. The diffractive features may include any of a variety of structures that diffract light including, but not limited to, one or more of grooves, ridges, holes and bumps at, in or on the surface. For example, the diffraction grating may include a plurality of substantially parallel grooves in the material surface. In another example, the diffraction grating may include a plurality of parallel ridges rising out of the material surface. The diffractive features (e.g., grooves, ridges, holes, bumps, etc.) may have any of a variety of cross-sectional shapes or profiles that provide diffraction including, but not limited to, one or more of a sinusoidal profile, a rectangular profile (e.g., a binary diffraction grating), a triangular profile and a saw tooth profile (e.g., a blazed grating).

According to various examples described herein, a diffraction grating (e.g., a diffraction grating of a multibeam element, as described below) may be employed to diffractively scatter or couple light out of a light guide (e.g., a plate light guide) as a light beam. In particular, a diffraction angle θₘ of or provided by a locally periodic diffraction grating may be given by equation (1) as:

$${θ}_{m} = {sin}^{- 1} ( n sin {θ}_{i} - \frac{m λ}{d} ) \qquad ( 1 )$$

where λ is a wavelength of the light, m is a diffraction order, n is an index of refraction of a light guide, d is a distance or spacing between features of the diffraction grating, θᵢ is an angle of incidence of light on the diffraction grating. For simplicity, equation (1) assumes that the diffraction grating is adjacent to a surface of the light guide and a refractive index of a material outside of the light guide is equal to one (i.e., nₒᵤₜ=1). In general, the diffraction order m is given by an integer. A diffraction angle θₘ of a light beam produced by the diffraction grating may be given by equation (1) where the diffraction order is positive (e.g., m>0). For example, first-order diffraction is provided when the diffraction order m is equal to one (i.e., m=1).

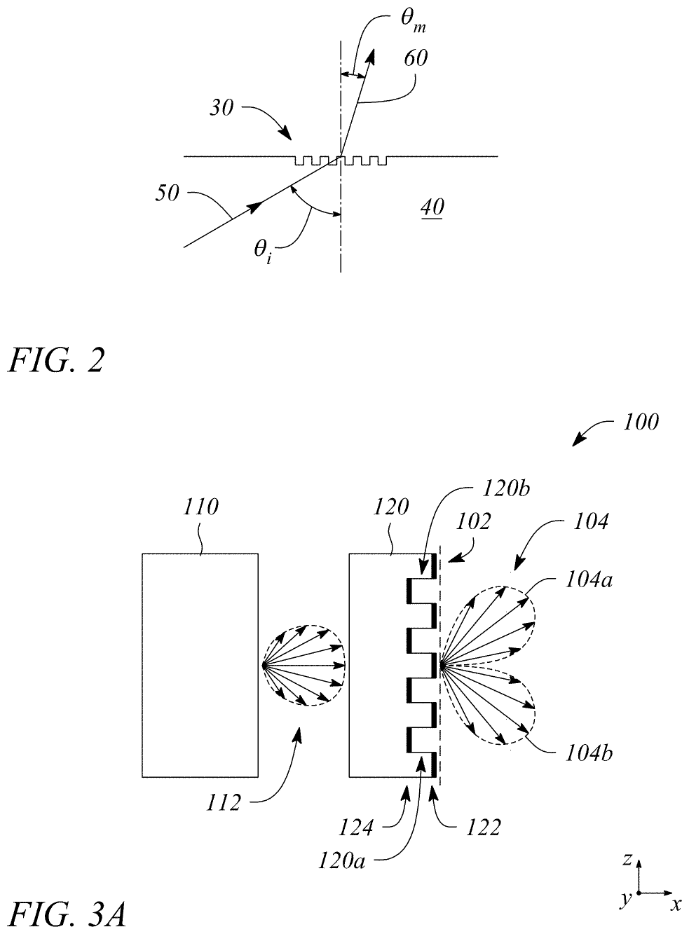

FIG. 2 illustrates a cross-sectional view of a diffraction grating 30 in an example, according to an embodiment consistent with the principles described herein. For example, the diffraction grating 30 may be located on a surface of a light guide 40. In addition, FIG. 2 illustrates a light beam 50 incident on the diffraction grating 30 at an incident angle θᵢ. The incident light beam 50 may be a beam of guided light (i.e., a guided light beam) within the light guide 40. Also illustrated in FIG. 2 is a directional light beam 60 diffractively produced and coupled-out by the diffraction grating 30 as a result of diffraction of the incident light beam 50. The directional light beam 60 has a diffraction angle θₘ (or ‘principal angular direction’ herein) as given by equation (1). The diffraction angle θₘ may correspond to a diffraction order ‘m’ of the diffraction grating 30, for example diffraction order m=1 (i.e., a first diffraction order).

By definition herein, a ‘multibeam element’ is a structure or element of a backlight or a display that produces light that includes a plurality of light beams. In some embodiments, the multibeam element may be optically coupled to a light guide of a backlight to provide the plurality of light beams by coupling or scattering out a portion of light guided in the light guide. Further, the light beams of the plurality of light beams produced by a multibeam element have different principal angular directions from one another, by definition herein. In particular, by definition, a light beam of the plurality has a predetermined principal angular direction that is different from another light beam of the light beam plurality. As such, the light beam is referred to as a ‘directional light beam’ and the light beam plurality may be termed a ‘directional light beam plurality,’ by definition herein.

Furthermore, the directional light beam plurality may represent a light field. For example, the directional light beam plurality may be confined to a substantially conical region of space or have a predetermined angular spread that includes the different principal angular directions of the light beams in the light beam plurality. As such, the predetermined angular spread of the light beams in combination (i.e., the light beam plurality) may represent the light field.

According to various embodiments, the different principal angular directions of the various directional light beams of the plurality are determined by a characteristic including, but not limited to, a size (e.g., length, width, area, etc.) of the multibeam element. In some embodiments, the multibeam element may be considered an ‘extended point light source’, i.e., a plurality of point light sources distributed across an extent of the multibeam element, by definition herein. Further, a directional light beam produced by the multibeam element has a principal angular direction given by angular components {θ, ϕ}, by definition herein, and described above with respect to FIG. 1B.

Herein a ‘collimator’ is defined as substantially any optical device or apparatus that is configured to collimate light. For example, a collimator may include, but is not limited to, a collimating mirror or reflector, a collimating lens, a diffraction grating, a tapered light guide, and various combinations thereof. According to various embodiments, an amount of collimation provided by the collimator may vary in a predetermined degree or amount from one embodiment to another. Further, the collimator may be configured to provide collimation in one or both of two orthogonal directions (e.g., a vertical direction and a horizontal direction). That is, the collimator may include a shape or similar collimating characteristic in one or both of two orthogonal directions that provides light collimation, according to some embodiments.

Herein, a ‘collimation factor’ is defined as a degree to which light is collimated. In particular, a collimation factor defines an angular spread of light rays within a collimated beam of light, by definition herein. For example, a collimation factor σ may specify that a majority of light rays in a beam of collimated light is within a particular angular spread (e.g., +/−σ degrees about a central or principal angular direction of the collimated light beam). The light rays of the collimated light beam may have a Gaussian distribution in terms of angle and the angular spread may be an angle determined by at one-half of a peak intensity of the collimated light beam, according to some examples.

Herein, a ‘light source’ is generally defined as a source of light (e.g., an optical emitter configured to produce and emit light). For example, the light source may comprise an optical emitter such as a light emitting diode (LED) that emits light when activated or turned on. In particular, herein the light source may be substantially any source of light or comprise substantially any optical emitter including, but not limited to, one or more of a light emitting diode (LED), a laser, an organic light emitting diode (OLED), a polymer light emitting diode, a plasma-based optical emitter, a fluorescent lamp, an incandescent lamp, and virtually any other source of light. The light produced by the light source may have a color (i.e., may include a particular wavelength of light), or may be a range of wavelengths (e.g., white light). In some embodiments, the light source may comprise a plurality of optical emitters. For example, the light source may include a set or group of optical emitters in which at least one of the optical emitters produces light having a color, or equivalently a wavelength, that differs from a color or wavelength of light produced by at least one other optical emitter of the set or group. The different colors may include primary colors (e.g., red, green, blue) for example. In another example, plurality of optical emitters may be arranged in a row or as array across a width of the light source.

Further, as used herein, the article ‘a’ is intended to have its ordinary meaning in the patent arts, namely ‘one or more’. For example, ‘a multibeam element’ means one or more multibeam elements and as such, ‘the multibeam element’ means ‘the multibeam element(s)’ herein. Also, any reference herein to ‘top’, ‘bottom’, ‘upper’, ‘lower’, ‘up’, ‘down’, ‘front’, ‘back’, ‘first’, ‘second’, ‘left’ or ‘right’ is not intended to be a limitation herein. Herein, the term ‘about’ when applied to a value generally means within the tolerance range of the equipment used to produce the value, or may mean plus or minus 10%, or plus or minus 5%, or plus or minus 1%, unless otherwise expressly specified. Further, the term ‘substantially’ as used herein means a majority, or almost all, or all, or an amount within a range of about 51% to about 100%. Moreover, examples herein are intended to be illustrative only and are presented for discussion purposes and not by way of limitation.

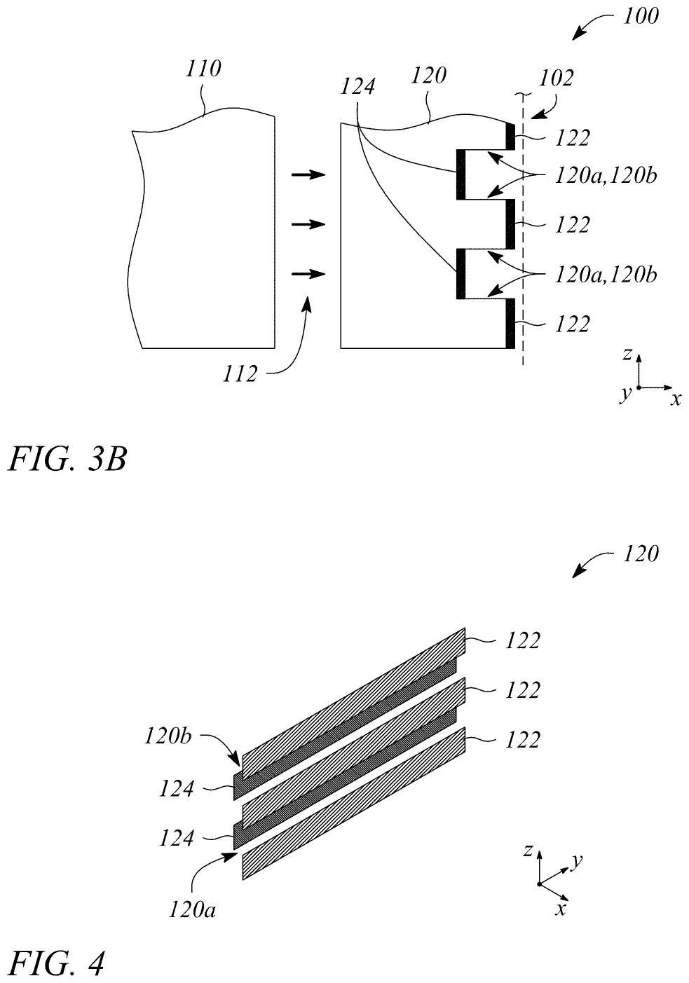

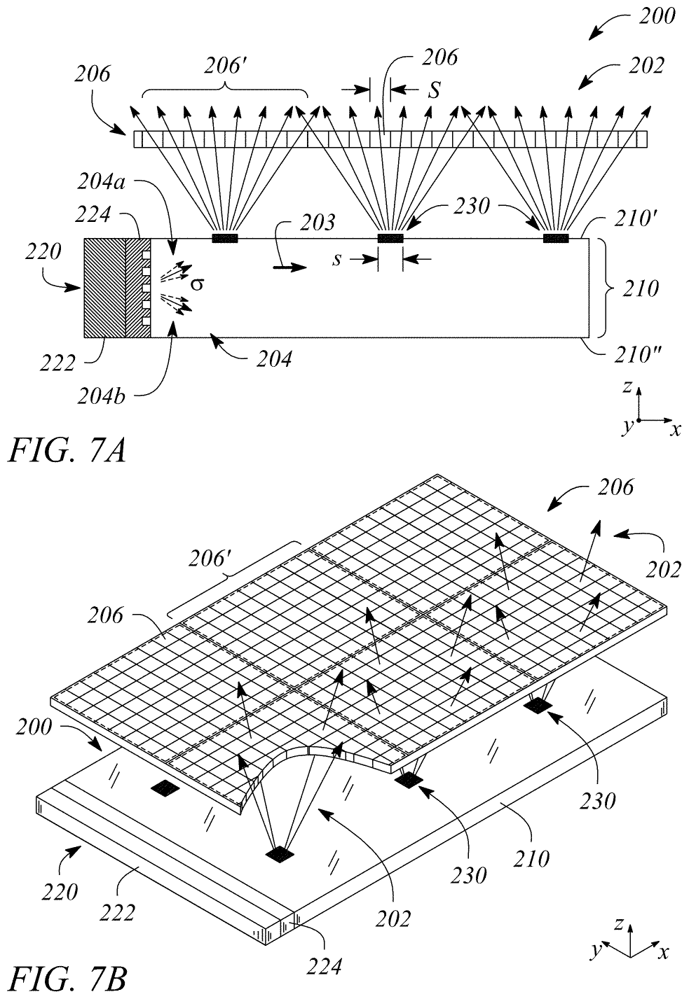

In accordance with principles disclosed herein, a light source is provided. FIG. 3A illustrates a cross-sectional view of a light source 100 in an example, according to an embodiment consistent with the principles described herein. FIG. 3B illustrates a magnified cross-sectional view of a portion of the light source 100 of FIG. 3A in an example, according to an embodiment consistent with the principles described herein. In particular, FIGS. 3A and 3B depict an embodiment of the light sources 100 useful, for example, in a multiview backlight, as describe in more detail below with reference to FIGS. 7A and 7B.

According to various embodiments, the light source 100 comprises an optical emitter 110. In some embodiments, the optical emitter 110 may be or comprise any of a variety of optical emitters including, but not limited to, a light emitting diode (LED) or a laser (e.g., a laser diode). In some embodiments, the optical emitter 110 may comprise a plurality or an array of optical emitters (e.g., a LED array) distributed in a horizontal direction (y-direction) or across a width of the light source 100. The optical emitter 110 is configured to emit light as emitted light 112. In various embodiments, the emitted light 112 may be directed by the optical emitter 110 in a general direction toward an output aperture 102 of the light source 100. In this connection and when the optical emitter 110 comprises an LED, the light source 100 may be referred to as an LED package. Further, the optical emitter 110 may provide the emitted light 112 in a relatively uncollimated form or as a beam of light having a relatively broad beamwidth (e.g., greater than about ninety degrees), in some embodiments. In particular, an emission pattern of the emitted light 112 may have a Lambertian distribution, i.e., a single lobe as illustrated in FIG. 3A, in some embodiments.

As illustrated, the light source 100 further comprises an emission control layer 120. According to various embodiments (e.g., as illustrated), the emission control layer 120 comprises a first plurality of light-blocking elements 122 and a second plurality of light-blocking elements 124. As illustrated, the first plurality of light-blocking elements 122 or light-blocking elements 122 of the first plurality are spaced apart from one another in a vertical direction at the output aperture 102, e.g., along a z-axis. According to various embodiments, the second plurality of light-blocking elements 124 or light-blocking elements of the second plurality are displaced from the output aperture 102 and interleaved with the first plurality of light-blocking elements 122. For example, the second plurality of light-blocking elements 124 is illustrated in FIGS. 3A-3B as being displaced toward the optical emitter 110 along an x-axis. Further, as illustrated, individual light-blocking element 124 of the second plurality are interleaved between individual light-blocking elements 122 of the first plurality. As such, when considered in an x-direction in FIG. 3A, the individual light-blocking elements 124 are aligned with spaces between the individual light-blocking elements 122, i.e., the second plurality of light-blocking elements 124 is interleaved with the first plurality of light-blocking elements 122 along the z-direction when considered from the x-direction, as illustrated.

According to various embodiments, the emission control layer is configured to transmit a portion of the emitted light 112 through gaps 120a, 120b between light-blocking elements 122, 124 of the first plurality of light-blocking elements 122 and the second plurality of light-blocking elements 124. Transmission of the emitted light portion is configured to provide output light 104 having a bifurcated emission pattern in the vertical direction, e.g., z-direction, at the output aperture 102 of the light source 100, as illustrated. In particular, the bifurcated emission pattern of the output light may comprise a first lobe 104a having a positive angle in the vertical direction (z-direction) and a second lobe 104b having a negative angle in the vertical direction (z-direction), according to some embodiments. The first lobe 104a of the bifurcated emission pattern of the output light 104 may comprise a portion of the emitted light 112 transmitted through a set of first gaps 120a, while a set of second gaps 120b through which another portion of the emitted light 112 is transmitted may provide output light 104 of the second lobe 104b, for example. Further, the positive and negative angles of the first and second lobes 104a, 104b of the bifurcated emission pattern may be angles defined in an x-z plane relative to a surface normal of the output aperture 102, i.e., the x-axis as illustrated in FIG. 3A.

According to various embodiments, the light-blocking elements 122, 124 may comprise virtually any opaque material that blocks or at least substantially block transmission of light. For example, the light-blocking elements 122, 124 may comprise a black paint or black ink. In another example, light-blocking elements 122, 124 may comprise an opaque transparent material, layer, or strip. In some embodiments, the light-blocking elements 122, 124 may comprise a reflective material. In particular, the light-blocking elements 122, 124 may comprise one or more of a one of a reflective metal (e.g., aluminum, gold, silver, copper, nickel, etc.) and a reflective metal-polymer composite (e.g., an aluminum-polymer composite). In some embodiments, the light-blocking elements 122, 124 may comprise the same material (e.g., may both be a reflective metal or reflective metal-polymer composite). In other embodiments, materials and material characteristics of the light-blocking elements 122 of the first plurality may differ from materials and material characteristics of the light-blocking elements 124 of the second plurality. For example, the first plurality of light-blocking elements 122 may comprise a reflective material and the second plurality of light-blocking elements 124 may comprise an opaque, but substantially non-reflective, material.

In some embodiments, the light-blocking elements 122, 124 of the first and second pluralities are or comprise strips of a material (e.g., an opaque material, a reflective material, etc.). FIG. 4 illustrates a perspective view of an emission control layer 120 in an example, according to an embodiment consistent with the principles described herein. As illustrated in FIG. 4, the first plurality of light-blocking elements 122 comprises strips of opaque material spaced apart from one another in the z-direction, e.g., in a plane of the output aperture 102. The second plurality of light-blocking elements 124 illustrated in FIG. 4 is displaced from the plane of the first plurality in the x-direction. Further, light-blocking elements 124 of the second plurality also comprise strips of opaque material that are spaced apart from one another in the z-direction to interleave with the first plurality of light-blocking elements 122. Also illustrated in FIG. 4 are the first and second gaps 120a, 120b between the light-blocking elements 122,124 of the first plurality of light-blocking elements 122 and the second plurality of light-blocking elements 124.

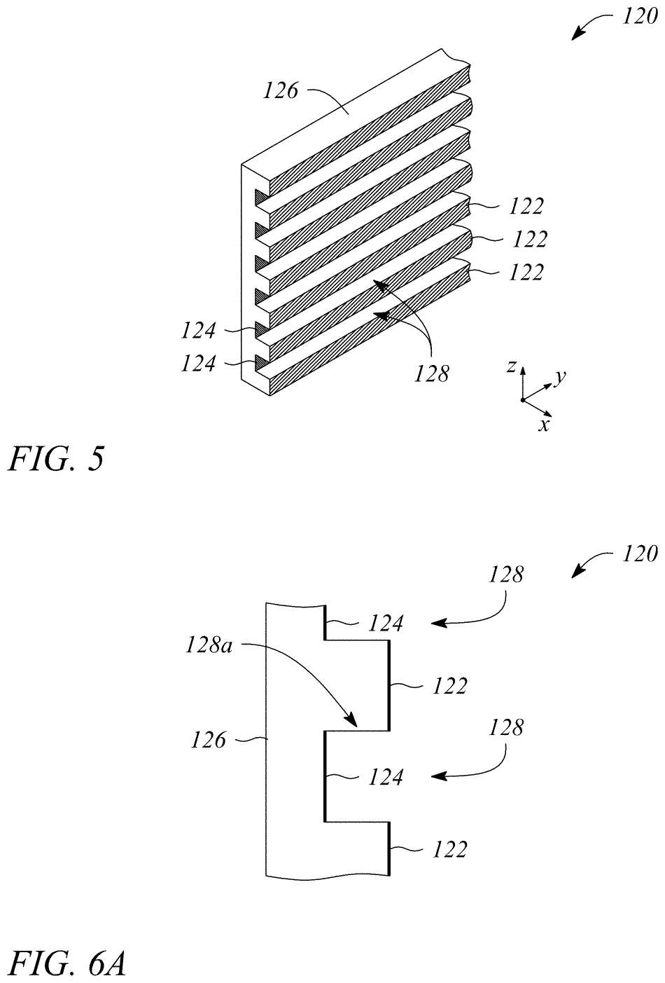

According to some embodiments, emission control layer may further comprise sheet or layer of transparent material between the optical emitter and the output aperture, the transparent material layer having a plurality of grooves oriented in a horizontal direction in a surface of the transparent material layer adjacent to the output aperture. FIG. 5 illustrates a perspective view of an emission control layer 120 in an example, according to an embodiment consistent with the principles described herein. In particular, FIG. 5 illustrates an emission control layer 120 comprising a layer of transparent material 126 having grooves 128 oriented in a horizontal direction (y-direction) in a surface of the transparent material 126. According to these embodiments, the light-blocking elements 122 of the first plurality of light-blocking elements 122 may comprise a layer of light-blocking material disposed on transparent material layer surface between grooves 128 of the groove plurality, e.g., as illustrated. Further, as illustrated, the light-blocking elements 124 of the second plurality of light-blocking elements 124 may comprise a layer of light-blocking material disposed on or at a bottom of each of the grooves 128 of the groove plurality, according to some of these embodiments. For example, a layer of reflective material (e.g., reflective metal or reflective metal-polymer composite) may be provided or deposited (e.g., by sputter deposition, evaporative deposition, printing, etc.) on the bottoms of the grooves 128 and on the surface of the layer of transparent material 126 between the grooves 128 to provide the light-blocking elements 122, 124. According to various embodiments, the transparent material 126 of the transparent material layer may comprise virtually any optically transparent or substantially transparent material including, but not limited to, one or more of various types of glass (e.g., silica glass, alkali-aluminosilicate glass, borosilicate glass, etc.), substantially optically transparent plastics or polymers (e.g., poly(methyl methacrylate) or ‘acrylic glass’, polycarbonate, etc.), and similar other dielectric materials.

According to various embodiments, the grooves 128 may have side walls with various shapes and configurations. For example, a side wall of a groove 128 of the groove plurality may be perpendicular or substantially perpendicular to the transparent material layer surface. In another example, a side wall of a groove 128 of the groove plurality may comprises a curved shape. A slope of the side wall may be either positive or negative and each side wall of the groove 128 may have either the same shape or different shapes from one another, according to various embodiments.

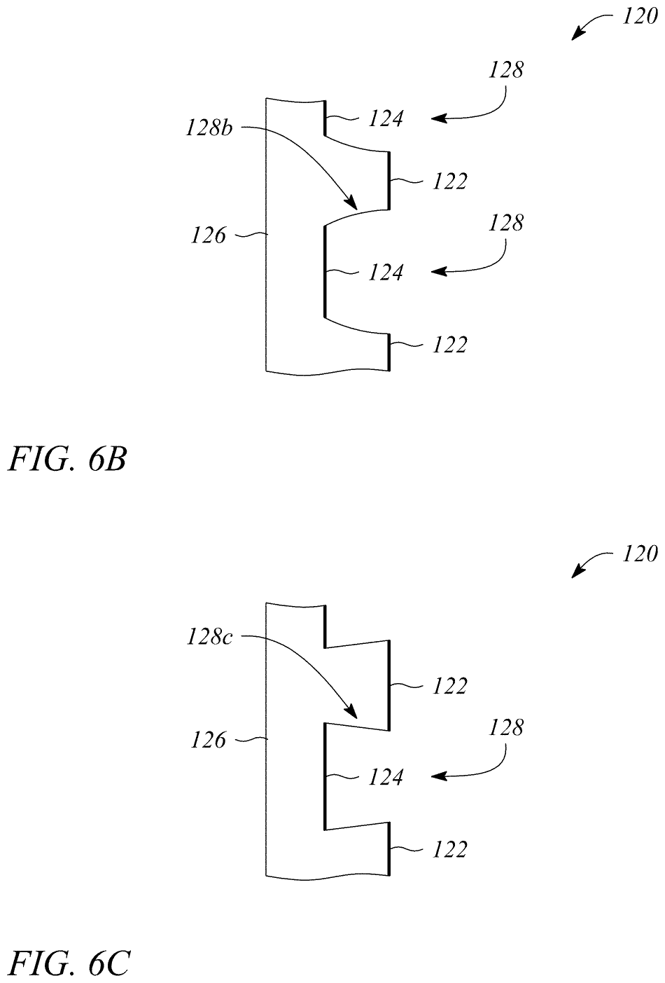

FIG. 6A illustrates a cross-sectional view of a groove 128 in a layer of transparent material 126 of an emission control layer 120 in an example, according to an embodiment consistent with the principles described herein. In particular, FIG. 6A illustrates the groove 128 having perpendicular side walls 128a. Also illustrated in FIG. 6A are light-blocking elements 122 of the first plurality of light-blocking elements 122 on the transparent material surface between grooves 128 of the groove plurality and light-blocking elements 124 of the second plurality of light-blocking elements 124 on or at the bottoms of the grooves 128. A width of the light-blocking elements 122, 124 respectively of the first plurality and the second plurality may be substantially similar by virtue of the perpendicular side walls 128a, for example as illustrated in FIG. 6A.

FIG. 6B illustrates a cross-sectional view of a groove 128 in a layer of transparent material 126 of the emission control layer 120 in an example, according to another embodiment consistent with the principles described herein. As illustrated in FIG. 6B, the groove 128 has curved side walls 128b. FIG. 6B also illustrates light-blocking elements 122 of the first plurality on the surface of the transparent material between grooves 128 of the groove plurality and light-blocking elements 124 of the second plurality on or at the bottoms of the grooves 128.

FIG. 6C illustrates a cross-sectional view of a groove 128 in a layer of transparent material 126 of the emission control layer 120 in an example, according to yet another embodiment consistent with the principles described herein. In particular, FIG. 6C illustrates the groove 128 having sloped side walls 128c. The sloped side walls 128c illustrated in FIG. 6C have a negative slope, as illustrated by way of example and not limitation. By virtue of the negative slope, the light-blocking elements 124 of the second plurality at the bottom of the grooves 128 are wider than the light-blocking elements 122 of the first plurality, as illustrated in FIG. 6C. Note that, if the sloped side walls 128c were to have a positive slope (not illustrated), the light-blocking elements 124 of the second plurality of light-blocking elements 124 would be generally narrower than the light-blocking elements 122 of the first plurality.

In some embodiments (not illustrated), for example when the light-blocking elements 122, 124 of one or both of the first plurality of light-blocking elements 122 and the second plurality of light-blocking elements 124 comprises a reflective material, the emission control layer 120 may be configured recycle light reflected by the light-blocking elements 122, 124. In particular, the light-blocking elements 122, 124 may be configured to reflect a portion of the emitted light 112 away from the output aperture 102 and toward the optical emitter 110. The reflected portion may be recycled and redirected toward the emission control layer 120 by the optical emitter 110, according to some embodiments. For example, the optical emitter 110 may comprise a reflector or a reflective scattering layer that redirects the reflected portion back toward the output aperture 102. The reflector may be part of a housing of the optical emitter 110, for example. In another example, the emission control layer 120 may comprise the reflector or partially reflective layer, e.g., at an input surface of the emission control layer 120, that is configured to selectively reflect and redirect the reflected portion back toward the output aperture 102 of the light source 100. Examples of partially reflective layers include, but are not limited to, a reflective polarizer and a so-called half-silvered mirror. Recycling the reflected portion may yield improved brightness or increased power efficiency of the light source 100, according to various embodiments.

In some embodiments, one or more of a size or width of the light-blocking elements 122, 124, a displacement or separation between the first plurality of light-blocking elements 122 and the second plurality of light-blocking elements 124, and a number of light-blocking elements 122, 124 in the first plurality and the second plurality may be chosen to control characteristics of the bifurcated emission pattern. For example, by selecting or changing the displacement or separation, an angle of the first and second lobes 104a, 104b of the bifurcated emission pattern may be adjusted. In another example, a spread angle of the first and second lobes 104a, 104b may be determined by a width of the light-blocking elements 122, 124.

In some embodiments, the width of the light-blocking elements 122, 124 of the first plurality and the second plurality may be between about five micrometers μm (5 μm) and about fifty micrometers (50 μm). For example, the width of each of the light-blocking elements 122, 124 may be about twenty-five micrometers (25 μm). In other examples, the width of the light-blocking elements 122, 124 may be between about ten micrometers (10 μm) and about forty micrometers (40 μm) or between about twenty micrometers (20 μm) and about thirty micrometers (30 μm). In some embodiments, the displacement or separation between the first plurality of light-blocking elements 122 and the second plurality of light-blocking elements 124 may be between about five micrometers (5 μm) and about fifty micrometers (50 μm). For example, the displacement between the first plurality of light-blocking elements 122 and the second plurality may be about twenty-five micrometers (25 μm). In other examples, the displacement may be between about ten micrometers (10 μm) and about forty micrometers (40 μm) or between about twenty micrometers (20 μm) and about thirty micrometers (30 μm). In some embodiments, there may be between about three (3) and about fifty (50) light-blocking elements 122 in the first plurality or between about two (2) and about forty-nine (49) light-blocking elements 124 in the second plurality. For example, there may be about eight (8) light-blocking elements 122 in the first plurality and about seven (7) light-blocking elements 124 in the second plurality. In some embodiments, light-blocking elements 122, 124 in each of the first plurality and second plurality have equal widths, e.g., a duty cycle of fifty percent (50%). In other embodiments, a width of the light-blocking elements 122 of the first plurality may differ from a width of the light-blocking elements 124 of the second plurality. In these embodiments, the duty cycle of the light-blocking element widths may range between about one percent (1%) and about seventy-five percent (75%). Note that the width of light-blocking elements 122 of the first plurality may be either greater than or less than the width of the light-blocking elements 124 of the second plurality when the duty cycle is not fifty percent (50%), i.e., the duty cycle may be positive or negative in some embodiments. Further, the above width dimensions are based on a light guide thickness of about four hundred micrometers (400 μm) and may be adjusted accordingly for other light guide thicknesses, e.g., the light guide 210 described below.

In some embodiments, the light source 100 may be used to provide light to backlight such as, but not limited to, a multiview backlight. In particular, according to some embodiments of the principles described herein, a multiview backlight comprising a light source substantially similar to the light source 100 described above is provided.

FIG. 7A illustrates a cross sectional view of a multiview backlight 200 in an example, according to an embodiment consistent with the principles described herein. FIG. 7B illustrates a perspective view of a multiview backlight 200 in an example, according to an embodiment consistent with the principles described herein. The multiview backlight 200 illustrated in FIGS. 7A and 7B is configured to provide directional light beams 202 having different principal angular directions from one another (e.g., as a light field). In particular, the provided directional light beams 202 are directed away from the multiview backlight 200 in different principal angular directions corresponding to respective view directions of a multiview display, according to various embodiments. In some embodiments, the directional light beams 202 may be modulated (e.g., using light valves, as described below) to facilitate the display of information having 3D content.

As illustrated in FIGS. 7A-7B, the multiview backlight 200 comprises a light guide 210. The light guide 210 may be a plate light guide, according to some embodiments. The light guide 210 is configured to guide light along a length of the light guide 210 as guided light 204. For example, the light guide 210 may include a dielectric material configured as an optical waveguide. The dielectric material may have a first refractive index that is greater than a second refractive index of a medium surrounding the dielectric optical waveguide. The difference in refractive indices is configured to facilitate total internal reflection of the guided light 204 according to one or more guided modes of the light guide 210, for example.

In some embodiments, the light guide 210 may be a slab or plate optical waveguide comprising an extended, substantially planar sheet of optically transparent, dielectric material. The substantially planar sheet of dielectric material is configured to guide the guided light 204 using total internal reflection. According to various examples, the optically transparent material of the light guide 210 may include or be made up of any of a variety of dielectric materials including, but not limited to, one or more of various types of glass (e.g., silica glass, alkali-aluminosilicate glass, borosilicate glass, etc.) and substantially optically transparent plastics or polymers (e.g., poly(methyl methacrylate) or ‘acrylic glass’, polycarbonate, etc.). In some examples, the light guide 210 may further include a cladding layer (not illustrated) on at least a portion of a surface (e.g., one or both of the top surface and the bottom surface) of the light guide 210. The cladding layer may be used to further facilitate total internal reflection, according to some examples. According to various embodiments, the light guide 210 is configured to guide the guided light 204 according to total internal reflection at a non-zero propagation angle between a first guiding surface 210′ (e.g., ‘front’ surface or side) and a second guiding surface 210″ (e.g., ‘back’ surface or side) of the light guide 210. The guided light 204 may also be guided according to a collimation factor σ, according to some embodiments. As defined herein, a ‘non-zero propagation angle’ is an angle relative to a guiding surface (e.g., the first guiding surface 210′ or the second guiding surface 210″) of the light guide 210. Further, the non-zero propagation angle is both greater than zero and less than a critical angle of total internal reflection within the light guide 210, according to various embodiments. In FIG. 7A, a bold arrow indicating a propagation direction 203 of the guided light (e.g., directed in the x-direction) of the guided light 204 within the light guide 210.

As illustrated in FIGS. 7A-7B, the multiview backlight 200 further comprises a light source 220 configured to provide output light having a bifurcated emission pattern to be guided within the light guide 210 as the guided light 204. As illustrated, the light source 220 is optically coupled to an input edge of the light guide 210 and is configured to introduce the output light having the bifurcated emission pattern into the light guide 210 through the input edge. Once introduced and guided by the light guide 210, the output light becomes or serves as the guided light 204, which also has or includes a bifurcated emission pattern. In particular, the bifurcated emission pattern comprises a first lobe 204a having an angle toward the first guiding surface 210′ of the light guide 210 and a second lobe 204b having angle toward the second guiding surface 210″ of the light guide 210, as illustrated. Angles of the first and second lobes 204a, 204b may correspond to the non-zero propagation angles of the guided light 204, according to various embodiments.

According to some embodiments, the light source 220 may be substantially similar to the light source 100, described above. For example, as illustrated in FIG. 7A, the light source 220 comprises an optical emitter 222 and an emission control layer 224. In some embodiments, the optical emitter 222 may be substantially similar to the optical emitter 110 of the above-described light source 100. Similarly, the emission control layer 224 may be substantially similar to the emission control layer 120 described above with respect to the light source 100, according to some embodiments. In particular, the emission control layer 224 comprises a first plurality of light-blocking elements and a second plurality of light-blocking elements, the second plurality being displaced away from and interleaved with the first plurality, as illustrated. The emission control layer 224 converts light emitted by the optical emitter 222 into output light having the bifurcated emission pattern by transmitting light through gaps between the light-blocking elements of the first and second pluralities, respectively.

According to various embodiments (e.g., as illustrated in FIGS. 7A-7B), the multiview backlight 200 further comprises an array of multibeam elements 230 spaced apart from one another along a length of or generally across the light guide 210. In particular, the multibeam elements 230 of the multibeam element array are separated from one another by a finite space and represent individual, distinct elements along the light guide length.

According to some embodiments, the multibeam elements 230 of the array may be arranged in either a one-dimensional (1D) array or two-dimensional (2D) array. For example, the plurality of multibeam elements 230 may be arranged as a linear 1D array. In another example, the array of multibeam elements 230 may be arranged as a rectangular 2D array or even as a circular 2D array. Further, the array (i.e., 1D or 2D array) may be a regular or uniform array, in some examples. In particular, an inter-element distance (e.g., center-to-center distance or spacing) between the multibeam elements 230 may be substantially uniform or constant across the array. In other examples, the inter-element distance between the multibeam elements 230 may be varied one or both of across the array and along the length of the light guide 210.

According to various embodiments, each multibeam element 230 of the multibeam element array is configured to couple or scatter out a portion of the guided light 204 as the directional light beams 202. In particular, FIGS. 7A-7B illustrate the directional light beams 202 as a plurality of diverging arrows depicted as being directed way from the first (or front) guiding surface 210′ of the light guide 210. According to some embodiments (e.g., as illustrated in FIG. 7A), multibeam elements 230 of the multibeam element array may be located at the first guiding surface 210′ of the light guide 210. In other embodiments (not illustrated), the multibeam elements 230 may be located within the light guide 210. In yet other embodiments (not illustrated), the multibeam elements 230 may be located at or on the second guiding surface 210″ of the light guide 210. Further, a size of the multibeam element 230 may be comparable to a size of a light valve of a multiview display that employs the multiview backlight 200.

FIGS. 7A and 7B also illustrate an array of light valves 206 (e.g., of the multiview display), by way of example and not limitation. In various embodiments, any of a variety of different types of light valves may be employed as the light valves 206 of the light valve array including, but not limited to, one or more of liquid crystal light valves, electrophoretic light valves, and light valves based on or employing electrowetting. Further, as illustrated, there may be one unique set of light valves 206 for each multibeam element 230 of the array of multibeam elements 230. The light valve array may be configured to modulate the directional light beams 202 to provide a multiview image, for example. The unique set of light valves 206 may correspond to a multiview pixel 206′ of a multiview display configured to display the multiview image and that employs the multiview backlight 200 to provide the directional light beams 202, for example.

Herein, the ‘size’ may be defined in any of a variety of manners to include, but not be limited to, a length, a width or an area. For example, the size of a light valve (e.g., light valve 206) may be a length thereof and the comparable size of the multibeam element 230 may also be a length of the multibeam element 230. In another example, size may refer to an area such that an area of the multibeam element 230 may be comparable to an area of the light valve. In some embodiments, the size of the multibeam element 230 is comparable to the light valve size such that the multibeam element size is between about twenty-five percent (25%) and about two hundred percent (200%) of the light valve size. For example, if the multibeam element size is denoted ‘s’ and the light valve size is denoted ‘S’ (e.g., as illustrated in FIG. 7A), then the multibeam element size s may be given by equation (2) as:

¼S≤s≤2S (2)

In other examples, the multibeam element size is greater than about fifty percent (50%) of the light valve size, or about sixty percent (60%) of the light valve size, or about seventy percent (70%) of the light valve size, or greater than about eighty percent (80%) of the light valve size, or greater than about ninety percent (90%) of the light valve size, and the multibeam element is less than about one hundred eighty percent (180%) of the light valve size, or less than about one hundred sixty percent (160%) of the light valve size, or less than about one hundred forty percent (140%) of the light valve size, or less than about one hundred twenty percent (120%) of the light valve size. According to some embodiments, the comparable sizes of the multibeam element 230 and the light valve may be chosen to reduce, or in some examples to minimize, dark zones between views of the multiview display, while at the same time reducing, or in some examples minimizing, an overlap between views of the multiview display or equivalently of the multiview image.

According to various embodiments, the multibeam elements 230 may comprise any of a number of different structures configured to couple out a portion of the guided light 204. For example, the different structures may include, but are not limited to, diffraction gratings, micro-reflective elements, micro-refractive elements, or various combinations thereof. In some embodiments, the multibeam element 230 comprising a diffraction grating is configured to diffractively couple out the guided light portion as the plurality of directional light beams 202 having the different principal angular directions. In other embodiments, the multibeam element 230 comprising a micro-reflective element is configured to reflectively couple out the guided light portion as the plurality of directional light beams 202, or the multibeam element 230 comprising a micro-refractive element is configured to couple out the guided light portion as the plurality of directional light beams 202 by or using refraction (i.e., refractively couple out the guided light portion).

In some embodiments, an optical emitter of the light source 220 is substantially similar to the optical emitter 110, described above. For example, the optical emitter of the light source 220 may comprise substantially any source of light including, but not limited to, one or more light emitting diodes (LEDs) or a laser (e.g., laser diode). In some embodiments, the light source 220 may be configured produce a substantially monochromatic light having a narrowband spectrum denoted by a particular color. In particular, the color of the monochromatic light may be a primary color of a particular color space or color model (e.g., a red-green-blue (RGB) color model). In other examples, the light source 220 may serve as a substantially broadband light source configured to provide substantially broadband or polychromatic light. For example, the light source 220 may provide white light, e.g., as described above with respect to the light source 100. In some embodiments, the light source 220 may comprise a plurality of different optical emitters configured to provide different colors of light, e.g., a plurality of light sources 220. The different optical emitters may be configured to provide light having different, color-specific, non-zero propagation angles of the guided light 204 corresponding to each of the different colors of light, in some embodiments.

In some embodiments, the multiview backlight 200 is configured to be substantially transparent to light in a direction through the light guide 210 orthogonal to a propagation direction 203 of the guided light 204 having the bifurcated emission pattern. In particular, the light guide 210 and the spaced apart multibeam elements 230 of the multibeam element array allow light to pass through the light guide 210 through both the first guiding surface 210′ and the second guiding surface 210″, in some embodiments. Transparency may be facilitated, at least in part, due to both the relatively small size of the multibeam elements 230 and the relatively large inter-element spacing (e.g., one-to-one correspondence with multiview pixels 206′) of the multibeam element 230. Further, especially when the multibeam elements 230 comprise diffraction gratings, the multibeam elements 230 may also be substantially transparent to light propagating orthogonal to the guiding surfaces 210′, 210″, according to some embodiments. Transparency may facilitate incorporation and use of a broad-angle backlight adjacent to the second guiding surface 210″ to provide broad-angle emitted light, for example. The broad-angle emitted light may be used to display two-dimensional (2D) images on a multiview display that includes both the multiview backlight 200 and the broad-angle backlight, in some embodiments.

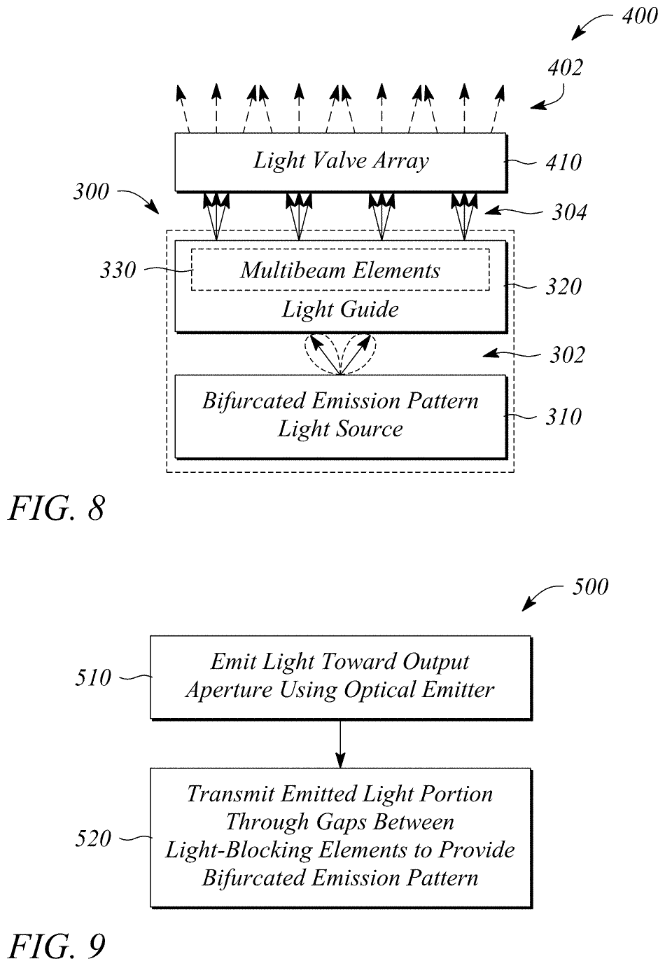

FIG. 8 illustrates a block diagram of a multiview backlight 300 in an example, according to another embodiment consistent with the principles described herein. As illustrated in FIG. 8, the multiview backlight 300 comprises a bifurcated emission pattern light source 310. The bifurcated emission pattern light source 310 comprises an optical emitter configured to emit light. The bifurcated emission pattern light source 310 further comprises an emission control layer configured to convert the light emitted by the optical emitter into output light 302 having the bifurcated emission pattern.

The multiview backlight 300 illustrated in FIG. 8 further comprises a light guide 320. The light guide 320 is configured to receive and guide the output light 302 as guided light. According to various embodiments, the bifurcated emission pattern of the output light 302 comprises a first lobe angled toward a first guiding surface of the light guide and a second lobe angled toward a second guiding surface of the light guide 320. In some embodiments, the light guide 320 may be substantially similar to the light guide 210 of the multiview backlight 200, as described above.

According to various embodiments, the multiview backlight 300 further comprises an array of multibeam elements 330, as illustrated in FIG. 8. The array of multibeam elements 330 are configured to scatter out a portion of the guided light as a plurality of directional light beams 304 having different directions corresponding to respective different view directions of a multiview display or equivalently of a multiview image displayed on a multiview display that employs the multiview backlight 300. In various embodiments, each multibeam element 330 of the multibeam element array is configured to separately provide the plurality directional light beams 304 having the different directions.

In some embodiments, the bifurcated emission pattern light source 310 may be substantially similar to the light source 100 described above. In particular, the optical emitter may be substantially similar to the light source 100 and the emission control layer may be substantially similar to the emission control layer 120 of the above-described light source 100, in some embodiments.

For example, the emission control layer may comprise a first plurality of light-blocking elements spaced apart from one another in a vertical direction at an output aperture of the bifurcated emission pattern light source, in some embodiments. Further, the emission control layer may also comprise a second plurality of light-blocking elements displaced from the output aperture and interleaved with the first plurality of light-blocking elements. In some of these embodiments, the vertical direction is perpendicular or generally perpendicular to one or both of the first and second guiding surfaces of the light guide 320. According to various embodiments, the emission control layer is configured to transmit a portion of the light emitted by the optical emitter through gaps between light-blocking elements of the first plurality of light-blocking elements and the second plurality of light-blocking elements to provide the output light 302 having the bifurcated emission pattern at the output aperture.

In some embodiments, the emission control layer further comprises layer of transparent material between the optical emitter and the output aperture, the transparent material layer having a plurality of grooves oriented in a horizontal direction in a surface of the transparent material layer adjacent to the output aperture. In these embodiments, the light-blocking elements of the first plurality of light-blocking elements may comprise a layer of light-blocking material disposed on transparent material layer surface between grooves of the groove plurality. In addition, the light-blocking elements of the second plurality of light-blocking elements may comprise a layer of light-blocking material disposed at or on a bottom of each of the grooves of the groove plurality, in these embodiments. As with the transparent material 126 of the above-described emission control layer 120, the transparent material layer of the emission control layer may comprise virtually any optically transparent or substantially transparent material including, but not limited to, one or more of various types of glass (e.g., silica glass, alkali-aluminosilicate glass, borosilicate glass, etc.), substantially optically transparent plastics or polymers (e.g., poly(methyl methacrylate) or ‘acrylic glass’, polycarbonate, etc.), and similar other dielectric materials, according to various embodiments.

In some embodiments, a light-blocking element of one or both of the first plurality of light-blocking elements and the second plurality of light-blocking elements of the emission control layer may comprises a reflective material. The reflective material is configured to reflect a portion of the emitted light away from the output aperture and toward the optical emitter. The reflective material may comprise, but is not limited to, one or more of a reflective metal and a reflective metal-polymer composite (e.g., and aluminum-polymer composite). In embodiments described above that include the transparent material layer, the reflective material may be a layer deposited one or both of on transparent material surface between the grooves and at or on a bottom of the grooves. In some embodiments, the reflected portion may be recycled and redirected toward the emission control layer by the optical emitter. For example, a reflector or reflective member of the optical emitter may be configured to reflect the reflected portion back toward the emission control layer to provide recycling. As discussed above, recycling may improve one or both of an overall efficiency and a brightness of the bifurcated emission pattern light source 310, according to some embodiments.

In some embodiments, the light guide 320 may be substantially similar to the light guide 210 described above with respect to the multiview backlight 200. For example, the light guide 210 may be plate light guide. Further, the light guide 320 may comprise a dielectric material configured to guide light according to total internal reflection (TIR) between the first and second guiding surfaces of the light guide. Further, the light guide 320 may be configured to guide light at a non-zero propagation angle (e.g., angles corresponding to one or both of first and second lobes of the bifurcated emission pattern). In addition, the light guide 320 may be configured to guide light as collimated light having a predetermined collimation factor. According to various embodiments, the dielectric material of the light guide 320 may include or be made up of any of a variety of dielectric materials including, but not limited to, one or more of various types of glass (e.g., silica glass, alkali-aluminosilicate glass, borosilicate glass, etc.) and substantially optically transparent plastics or polymers (e.g., poly(methyl methacrylate) or ‘acrylic glass’, polycarbonate, etc.).

In some embodiments, the array of multibeam elements 330 may be substantially similar to the array of multibeam elements 230 described above with respect to the multiview backlight 200. For example, multibeam elements 330 of the multibeam element array may be spaced apart from one another along a length of or generally across the light guide 320. Further, the multibeam elements 230 may comprises one or more of a diffraction grating, a micro-reflective element, and a micro-refractive element optically connected to the light guide 320 and configured to scatter out the portion of the guided light. In some embodiments, a size of the multibeam element 330 may be between twenty-five percent (25%) and two hundred percent (200%) of a size of a light valve in an array of light valves of a multiview display that employs the multiview backlight 300.

In some embodiments (e.g., as illustrated), the multiview backlight 300 may be used in a multiview display to provide a multiview image. FIG. 8 further illustrates a multiview display 400. The multiview display 400 comprises the multiview backlight 300 and further comprises an array of light valves 410. The array of light valves 410 is configured to modulate directional light beams 304 of the directional light beam plurality, the modulated directional light beams 402 representing the multiview image. Dashed arrows extending from the array of light valves 410 represent modulated directional light beams 402, as illustrated in FIG. 8.

In accordance with other embodiments of principles described herein, a method of light source operation is provided. FIG. 9 illustrates a flow chart of a method 500 of light source operation, according to an embodiment consistent with the principles described herein. As illustrated in FIG. 9, the method 500 of light source operation comprises emitting 510 light using an optical emitter. According to various embodiments, the light is emitted 510 toward an output aperture of the light source as emitted light. In some embodiments, the optical emitter may be substantially similar to the optical emitter 110 described above with respect to the light source 100. For example, the optical emitter may comprise a light emitting diode (LED) or an array of LEDs. Emitting 510 light may produce light substantially similar to emitted light 112 described above.

As illustrated in FIG. 9, the method 500 further comprises transmitting 520 a portion of the emitted light through gaps between light-blocking elements of an emission control layer to provide output light having a bifurcated emission pattern at the output aperture. In some embodiments, the emission control layer and bifurcated emission pattern may be substantially similar to the emission control layer 120 and bifurcated emission pattern (e.g., first and second lobes 104a, 104b) described above with respect to the light source 100. In particular, the emission control layer may comprise a first plurality of light-blocking elements spaced apart from one another in a vertical direction at the output aperture and a second plurality of light-blocking elements displaced from the output aperture and interleaved with the first plurality of light-blocking elements. According to various embodiments, the gaps are between light-blocking elements of the first plurality and light-blocking elements of the second plurality.

In some embodiments, the light-blocking elements may comprise a reflective material. In these embodiments, the method 500 of light source operation further comprises reflecting another portion of the emitted light back towards the optical emitter to be recycled and redirected toward the emission control layer.

In some embodiments, the emission control layer further comprises layer of transparent material between the optical emitter and the output aperture, the transparent material layer having a plurality of grooves oriented in a horizontal direction in a surface of the transparent material layer adjacent to the output aperture. In these embodiments, the light-blocking elements of the first plurality of light-blocking elements may comprise a layer of light-blocking material (e.g., an opaque material or a reflective material) disposed on transparent material layer surface between grooves of the groove plurality. Similarly, in these embodiments, the light-blocking elements of the second plurality of light-blocking elements may comprise a layer of light-blocking material (e.g., an opaque material or a reflective material) disposed on a bottom of each of the grooves of the groove plurality.

In some embodiments (not illustrated), the method 500 of light source operation may further comprise receiving the output light having the bifurcated emission pattern from the light source using a light guide. A first lobe of the bifurcated emission pattern may be angled toward a first guiding surface of the light guide and a second lobe of the bifurcated emission pattern may be angled toward a second guiding surface of the light guide, according to some embodiments. The light guide may be substantially similar to the light guide 210 of the multiview backlight 200, in some embodiments.

In addition, in some embodiments (not illustrated), the method 500 of light source operation may further comprise guiding the received light within the light guide as guided light according to the bifurcated emission pattern. In some embodiments, the guided light may be guided one or both of at a non-zero propagation angle and having a predetermined collimation factor.

Further, the method 500 of light source operation may comprise scattering out from the light guide a portion of the guided light as a plurality of directional light beams using an array of multibeam elements. According to various embodiments, the directional light beams of the light beam plurality scattered out by the multibeam element array have directions corresponding to respective different view directions of a multiview display. In some embodiments, the array of multibeam elements may be substantially similar to the array of multibeam elements 230 of the above-described multiview backlight 200.

Thus, there have been described examples and embodiments of a light source configured to provide a bifurcated emission pattern, a multiview backlight that employs the light source, and a method of light source operation providing output light having the bifurcated emission pattern. It should be understood that the above-described examples are merely illustrative of some of the many specific examples that represent the principles described herein. Clearly, those skilled in the art can readily devise numerous other arrangements without departing from the scope as defined by the following claims.

What is claimed is:

1. A light source comprising:
an optical emitter configured to emit light toward an output aperture of the light source as emitted light; and
an emission control layer comprising a first plurality of light-blocking elements spaced apart from one another in a vertical direction at the output aperture and a second plurality of light-blocking elements displaced from the output aperture and interleaved with the first plurality of light-blocking elements,
wherein the emission control layer is configured to transmit a portion of the emitted light through gaps between light-blocking elements of the first plurality of light-blocking elements and the second plurality of light-blocking elements to provide output light having a bifurcated emission pattern in the vertical direction at the output aperture.

2. The light source of claim 1, wherein the optical emitter is a light emitting diode, an emission pattern of the emitted light having a Lambertian distribution.

3. The light source of claim 1, wherein the optical emitter comprises a reflector configured to reflect light toward the output aperture.

4. The light source of claim 1, wherein the light-blocking element of one or both of the first plurality of light-blocking elements and the second plurality of light-blocking elements comprises a reflective material.

5. The light source of claim 1, wherein emission control layer further comprises layer of transparent material between the optical emitter and the output aperture, the transparent material layer having a plurality of grooves oriented in a horizontal direction in a surface of the transparent material layer adjacent to the output aperture, and wherein the light-blocking elements of the first plurality of light-blocking elements comprise a layer of light-blocking material disposed on transparent material layer surface between grooves of the groove plurality and the light-blocking elements of the second plurality of light-blocking elements comprise a layer of light-blocking material disposed on a bottom of each of the grooves of the groove plurality.

6. The light source of claim 5, wherein the light-blocking material comprises one of a reflective metal and a reflective metal-polymer composite.

7. The light source of claim 5, wherein a side wall of a groove of the groove plurality is perpendicular to the transparent material layer surface.

8. The light source of claim 5, a side wall of a groove of the groove plurality comprises a curved shape.

9. The light source of claim 1, wherein the bifurcated emission pattern comprises a first lobe having a positive angle in the vertical direction and a second lobe having a negative angle in the vertical direction.

10. A multiview backlight comprising the light source of claim 1, the multiview backlight further comprising:
a light guide configured to guide light, the light source being optically coupled to an input edge of the light guide to provide the output light having the bifurcated emission pattern as guided light within the light guide; and
an array of multibeam elements spaced apart from one another along a length of the light guide, each multibeam element of the multibeam element array being configured to scatter out from the light guide a portion of the guided light as directional light beams having different principal angular directions corresponding to respective different view directions of a multiview display,
wherein the bifurcated emission pattern comprises a first lobe having an angle toward a first guiding surface of the light guide and a second lobe having angle toward a second guiding surface of the light guide, the second guiding surface being opposite to the first guiding surface in the vertical direction.

11. A multiview backlight comprising:
a bifurcated emission pattern light source comprising an optical emitter and an emission control layer configured to convert light emitted by the optical emitter into output light having the bifurcated emission pattern;
a light guide configured to receive and guide the output light as guided light, the bifurcated emission pattern of the output light comprising a first lobe angled toward a first guiding surface of the light guide and a second lobe angled toward a second guiding surface of the light guide; and
an array of multibeam elements configured to scatter out a portion of the guided light as a plurality of directional light beams having different directions corresponding to respective different view directions of a multiview display.

12. The multiview backlight of claim 11, wherein the emission control layer comprises a first plurality of light-blocking elements spaced apart from one another in a vertical direction at an output aperture of the bifurcated emission pattern light source and a second plurality of light-blocking elements displaced from the output aperture and interleaved with the first plurality of light-blocking elements, the vertical direction being perpendicular to one or both of the first and second guiding surfaces of the light guide, wherein the emission control layer is configured to transmit a portion of the light emitted by the optical emitter through gaps between light-blocking elements of the first plurality of light-blocking elements and the second plurality of light-blocking elements to provide the output light having the bifurcated emission pattern at the output aperture.

13. The multiview backlight of claim 12, wherein emission control layer further comprises layer of transparent material between the optical emitter and the output aperture, the transparent material layer having a plurality of grooves oriented in a horizontal direction in a surface of the transparent material layer adjacent to the output aperture, and wherein the light-blocking elements of the first plurality of light-blocking elements comprise a layer of light-blocking material disposed on transparent material layer surface between grooves of the groove plurality and the light-blocking elements of the second plurality of light-blocking elements comprise a layer of light-blocking material disposed on a bottom of each of the grooves of the groove plurality.

14. The multiview backlight of claim 12, wherein a light-blocking element of one or both of the first plurality of light-blocking elements and the second plurality of light-blocking elements comprises a reflective material configured to reflect a portion of the emitted light away from the output aperture and toward the optical emitter, the reflected portion of the emitted light being recycled and redirected toward the emission control layer by the optical emitter.

15. The multiview backlight of claim 11, wherein a size of the multibeam element is between twenty-five percent and two hundred percent of a size of a light valve in an array of light valves of the multiview display.

16. The multiview backlight of claim 11, wherein a multibeam element of the multibeam element array comprises one or more of a diffraction grating, a micro-reflective element, and a micro-refractive element optically connected to the light guide and configured to scatter out the portion of the guided light.

17. A multiview display comprising the multiview backlight of claim 11, the multiview display further comprising an array of light valves configured to modulate directional light beams of the directional light beam plurality, the modulated light beams representing a multiview image.

18. A method of light source operation, the method comprising:
emitting light using an optical emitter, the emitted light being directed toward an output aperture of the light source; and
transmitting a portion of the emitted light through gaps between light-blocking elements of an emission control layer to provide output light at the output aperture, the output light having a bifurcated emission pattern,
wherein the emission control layer comprises a first plurality of light-blocking elements spaced apart from one another in a vertical direction at the output aperture and a second plurality of light-blocking elements displaced from the output aperture and interleaved with the first plurality of light-blocking elements, the gaps being between light-blocking elements of the first plurality and light-blocking elements of the second plurality.

19. The method of light source operation of claim 18, wherein the light-blocking elements comprise a reflective material, the method of light source operation further comprising reflecting another portion of the emitted light back towards the optical emitter to be recycled and redirected toward the emission control layer.

20. The method of light source operation of claim 18, wherein the emission control layer further comprises layer of transparent material between the optical emitter and the output aperture, the transparent material layer having a plurality of grooves oriented in a horizontal direction in a surface of the transparent material layer adjacent to the output aperture, and wherein the light-blocking elements of the first plurality of light-blocking elements comprise a layer of light-blocking material disposed on transparent material layer surface between grooves of the groove plurality and the light-blocking elements of the second plurality of light-blocking elements comprise a layer of light-blocking material disposed on a bottom of each of the grooves of the groove plurality.

21. The method of light source operation of claim 18, further comprising:
receiving the output light having the bifurcated emission pattern from the light source using a light guide, a first lobe of the bifurcated emission pattern being angled toward a first guiding surface of the light guide and a second lobe of the bifurcated emission pattern being angled toward a second guiding surface of the light guide;
guiding the received output light within the light guide as guided light; and
scattering out from the light guide a portion of the guided light as a plurality of directional light beams using a multibeam element, the directional light beams of the directional light beam plurality having directions corresponding to respective different view directions of a multiview display.
